(19) United States
(12) Patent Application Publication
(10) Pub. No.: US 2010/0207371 A1
(43) Pub. Date: Aug. 19, 2010

(54) TRAILER FRAME ASSEMBLY

(75) Inventors: Anthony John Van Houdt, St. Helens, OR (US); Douglas D. Drader, Rickreall, OR (US); Daniel S. Urquhart, Stayton, OR (US); Gordon Scott Groshong, Oregon City, OR (US); Jason L. Kennedy, Portland, OR (US); Paul David Krohnert, Washougal, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Beall Corporation, Portland, OR (US)

(21) Appl. No.: 12/704,249

(22) Filed: Feb. 11, 2010

Related U.S. Application Data
(60) Provisional application No. 61/152,547, filed on Feb. 13, 2009.

(51) Int. Cl. B62D 21/03

(52) U.S. Cl. 280/796

(57) ABSTRACT

A trailer having a pair of closed, rectangular frame rails; a plurality of round pipe cross members, each cross member extending completely through each rectangular frame rail; and a plurality of axle suspension supports mounted on each rectangular frame rail.

### BACKGROUND

1. Technical Field

The present disclosure is directed to a frame for a pull trailer and, in addition, to a dump trailer chassis having a hybrid frame construction with improved draw bar.

2. Description of the Related Art

Loose material, such as sand, gravel, dirt, rock, coal, and bulk products such as potatoes and the like, are generally transported in dump trucks and trailers having an open box bed supported on a chassis. These vehicles utilize a variety of discharge methods, including end dump (where the front is raised), side dump (where one side is raised), bottom dump (where two clamshell style doors open under the load space), and live bottom trailer (where a conveyer moves the load out of the box, generally at the back).

Dump truck and trailer chasses employ a variety of frame designs. The most common is the ladder-style frame, which has two substantially parallel frame rails connected together by cross members. In the past, these cross members have been rectangular in shape, either of the same or smaller size than the rectangular cross-sectional shape of the side rails. In addition to the ladder-style frame, frameless chassis have also been designed. The long box rails and cross members are replaced with a single central long support, such as found in the Clement Fleet Star 2 trailer.

In the ladder-style frame, the design attempts to balance the need for strength versus a lighter weight, ease of design and construction versus serviceability, e.g., access and replacement of parts due to wear and tear, as well as increasing environmental concerns for efficient and non-harmful uses of environmental resources. Hence, new designs must keep these factors in mind while attempting to maintain or reduce costs of construction and service.

### BRIEF SUMMARY

A trailer frame and corresponding chassis are provided for a dump trailer and other applications that provide a hybrid of previous design techniques and unique features that overcomes disadvantages of prior designs while providing increased strength and reduced manufacturing and maintenance costs. In accordance with one embodiment of the present disclosure, a trailer frame assembly is provided that includes a pair of closed, rectangular frame rails, a plurality of round pipe cross members, each cross member extending completely through each rectangular frame rail to form a chassis, and a plurality of axle suspension supports mounted on each rectangular frame rail.

In accordance with another embodiment of the present disclosure, a trailer frame assembly is provided that includes a pair of closed, rectangular frame rails, a plurality of round pipe cross members, each cross member extending completely through each rectangular frame rail to form a chassis, and a draw bar assembly coupled to at least the rectangular frame rails, the draw bar having an outer reach and an inner reach slidably mounted on the outer reach with a reach lock mounted on the outer reach and configured to lock the inner reach in selectable positions with respect to the outer reach, the reach lock having an access covering releasably secured thereto.

In accordance with another aspect of the foregoing embodiment, a plurality of axles are mounted on the suspension members that in turn are mounted on the suspension supports attached to the rectangular frame rails.

In accordance with another aspect of the present disclosure, the assembly includes a dolly coupled to a ring plate that is attached to the frame rails, the dolly having a pair of leading suspension hangers at a forward end and a pair of suspension brackets at a rearward end, and a pair of yokes mounted on a forward face of the dolly that project forward to receive the draw bar assembly, the dolly adapted to pivot about a vertical axis with respect to the ring plate.

In accordance with a further aspect of the present disclosure, the assembly includes a top gusset extending from the rear cross beam to the mounting plates that support the rear guide on each side of the outer reach to provide strength and rigidity to the outer reach, the gussets shaped to have a reduced width midway between the rear cross beam and the first mounting plate, and having generally a plan form shape of a wide-angle V to form a large central opening in the outer reach to provide access to the inner reach for inspection and positioning.

In accordance with another aspect of the present disclosure, each of the plurality of round pipe cross members is attached to the pair of rectangular frame rails so that the frame rails are in spaced parallel relationship to one another and each cross member is attached at first and second ends to each respective frame rail, each cross member having the first and second ends extending through each rectangular frame rail to extend beyond an exterior sidewall of the frame rail. Ideally, each cross member has the first and second ends welded to the respective frame rail, and preferably the weld bead completely encircles each round pipe cross member first and second end, each weld beginning at a horizontal location on the cross member and proceeding around the cross member and back to the beginning of the weld at the horizontal position.

In accordance with another aspect of the foregoing embodiment each of the first and second ends of each cross member project approximately one-half inch beyond the exterior sidewall of each frame rail.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an isometric view of a trailer chassis utilizing a trailer frame assembly in accordance with one embodiment of the present disclosure;

FIG. 2 is an enlarged isometric view of the trailer chassis of FIG. 1;

FIG. 3 is an enlarged rear view of the trailer chassis of FIG. 2;

FIG. 4 is a top plan view of the trailer chassis of FIGS. 2 and 3;

FIG. 5 is an enlarged isometric view of a forward half of the trailer chassis of FIGS. 2-4;

FIGS. 6 and 7 are top and bottom isometric views, respectively, of a four-axle trailer frame assembly used in the embodiments of FIGS. 1-5;

FIGS. 8 and 9 are top and bottom isometric views, respectively, of a dolly used with the embodiment of FIGS. 1-7;

FIGS. 10 and 11 are top and bottom isometric views, respectively, of an alternative embodiment of a fixed trailer frame assembly formed in accordance with the present disclosure;

FIG. 12 is an isometric view of the draw assembly of FIG. 1; and

FIGS. 13 and 14 are top and bottom isometric views, respectively, of the inner reach of the draw assembly of FIG. 12.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with a chassis, including but not limited to axles, leaf springs, wheels, and tires have not been shown or described in detail in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

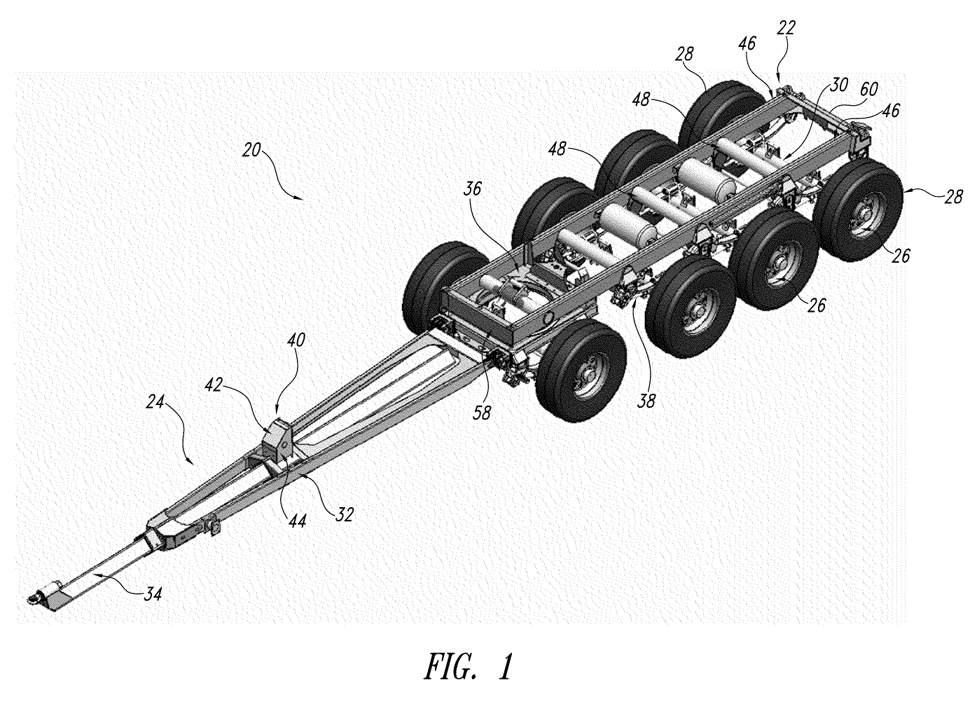

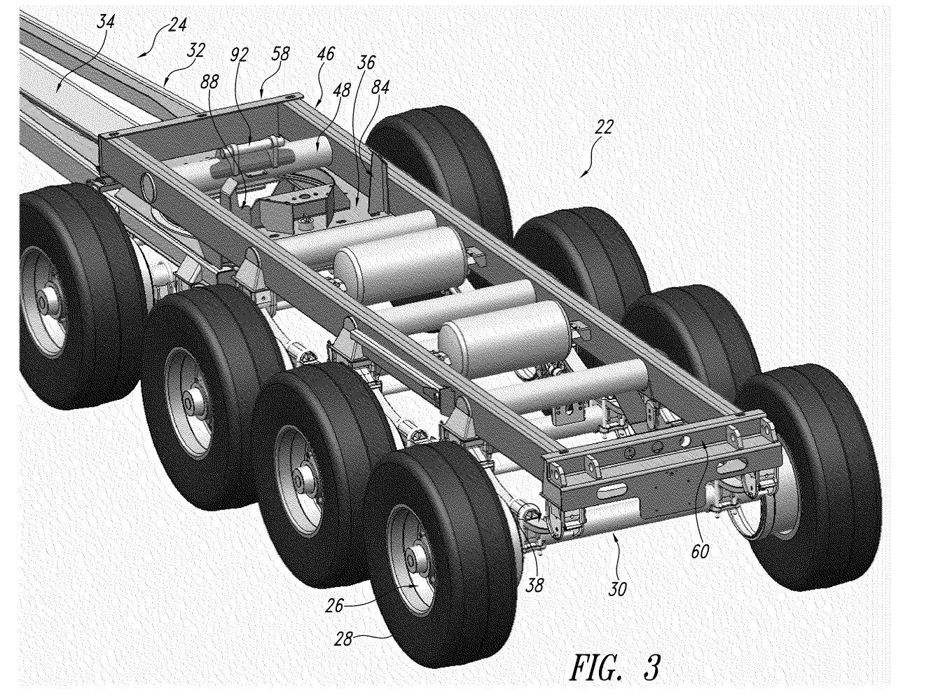

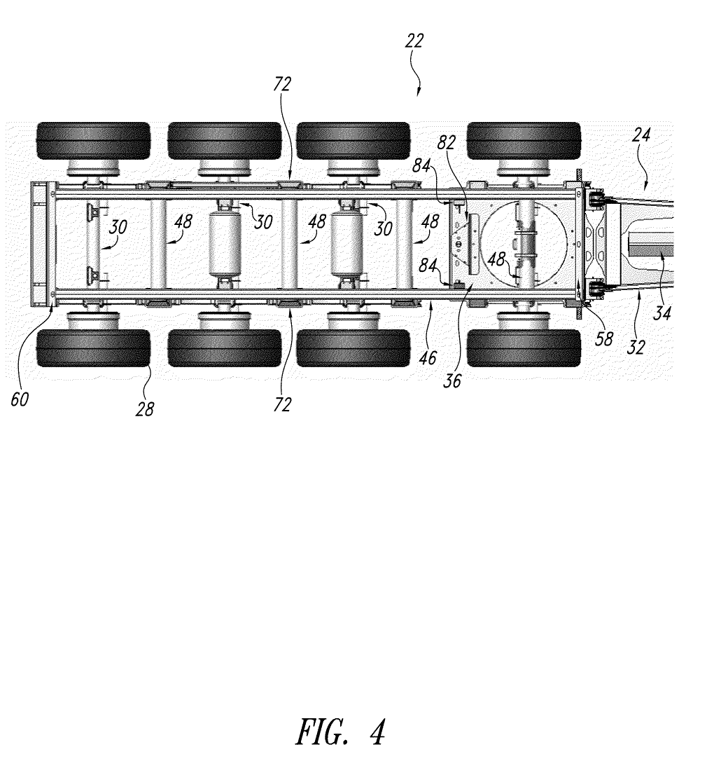

Referring initially to FIGS. 1-5, shown therein is a trailer chassis 20 that incorporates a trailer frame assembly 22 having a draw bar assembly 24 extending from one end thereof. The chassis includes a plurality of wheels 26 and tires 28 attached to axles 30 in pairs. In this embodiment eight wheels are coupled in pairs to four axles. The axles 30 are in turn coupled to the frame assembly 20 by leaf springs 38 in a conventional manner.

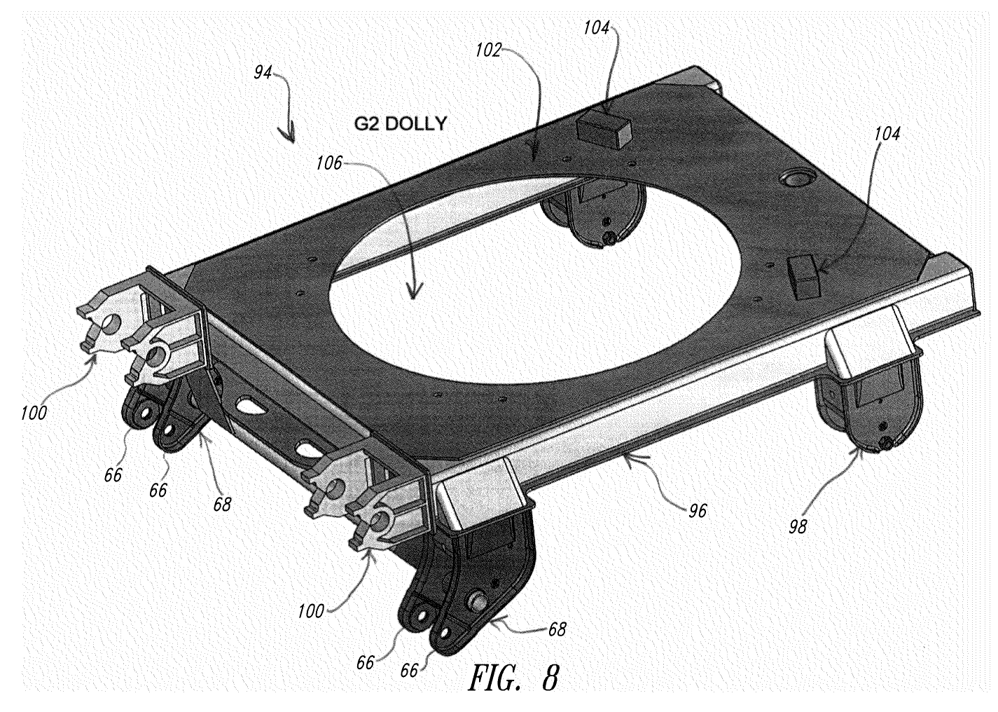

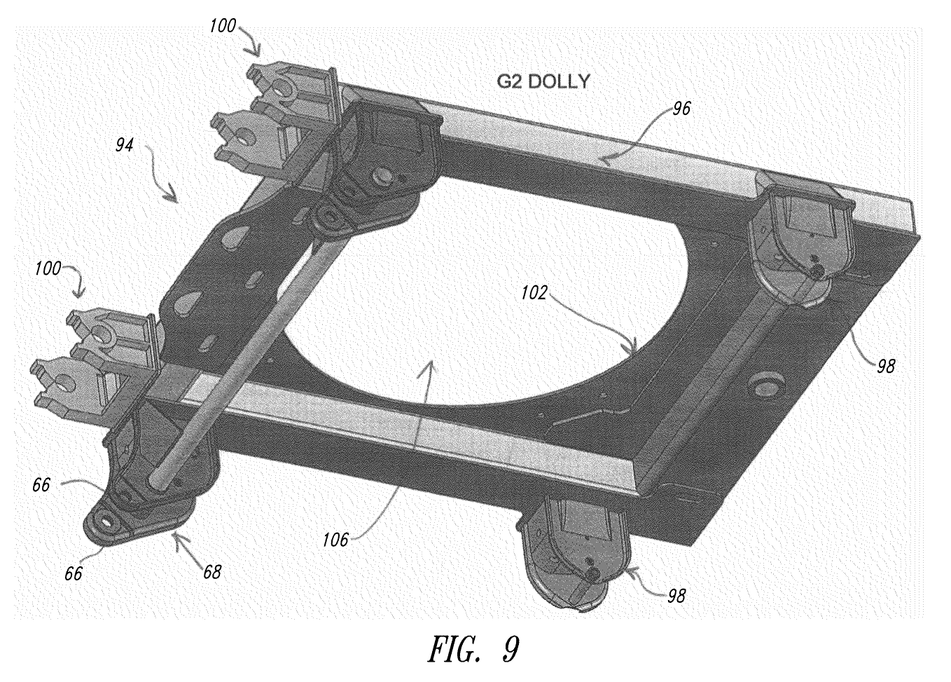

The draw bar assembly 24 utilizes an outer reach 32 having an inner reach 34 slidably mounted therein. The outer reach 32 is coupled to the frame assembly 20 via a ring plate 36 on a dolly 94 (illustrated in FIGS. 8 and 9) in a conventional manner. A reach lock 40 is formed on the outer reach 32 and configured to lock the inner reach 34 in selectable positions with respect to the outer reach 32. The reach lock 40 has an access covering 42 releasably secured thereto that protects the reach lock components from the elements while providing easy access to the reach lock components. The cover 42 is hingedly mounted to a housing 44 attached to the outer reach 32. Ideally, removable pins (not shown) secure the reach lock cover 42 in a closed position on the reach lock housing 44. The reach lock components inside the housing 44 utilize a standard shoe arrangement that will not be illustrated or described in detail herein inasmuch as the same is readily commercially available.

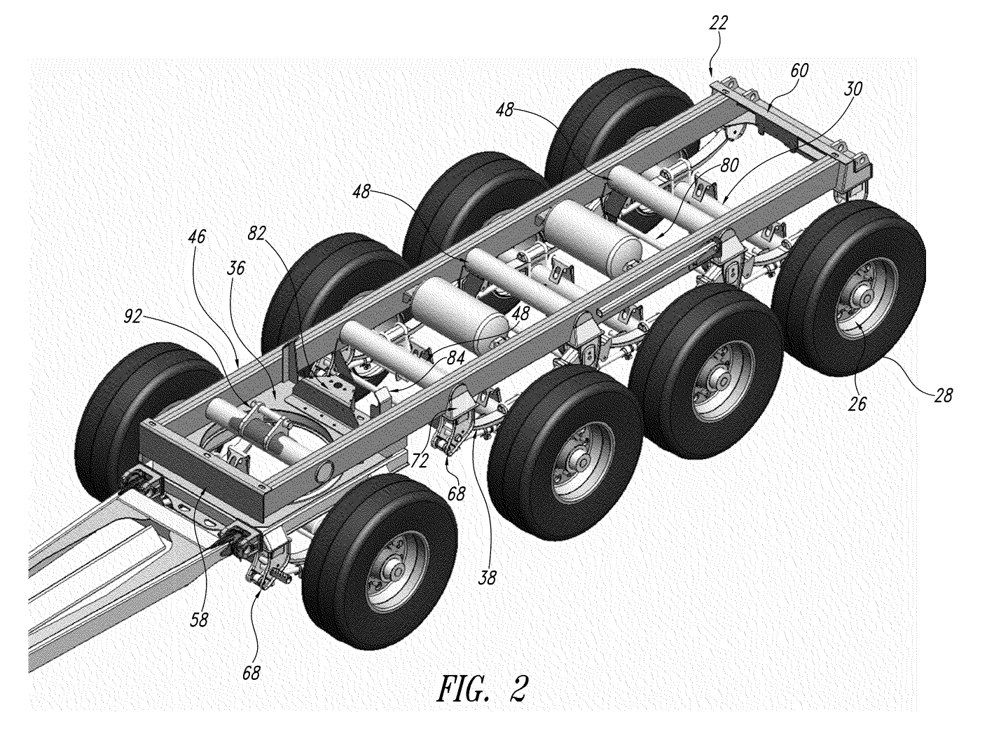

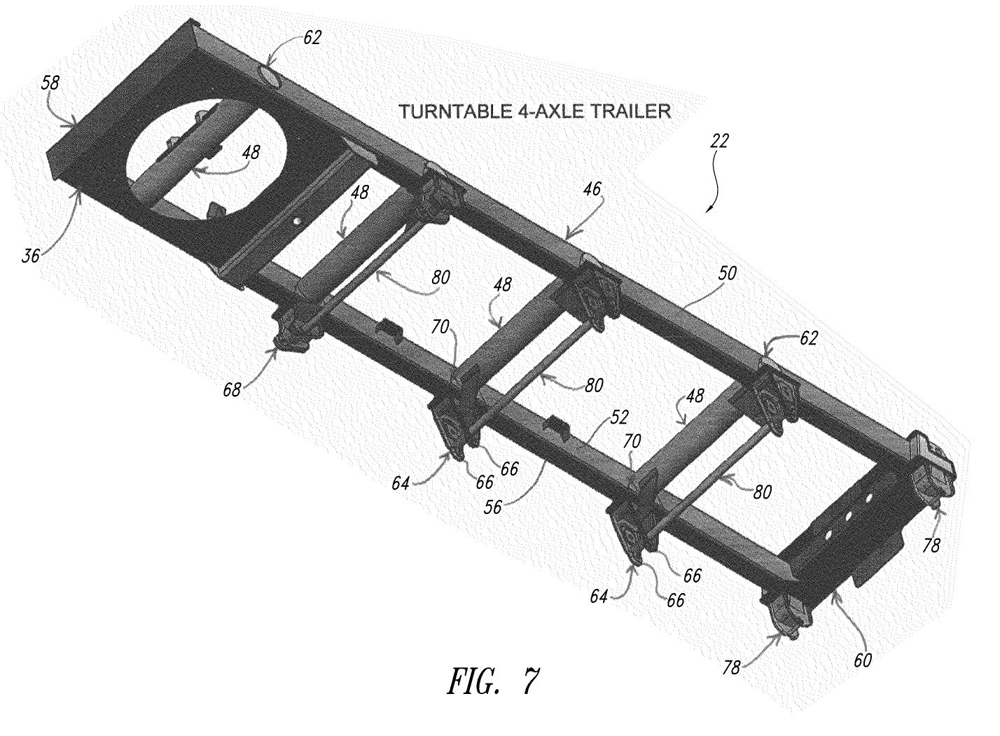

As shown in more detail in FIGS. 2-6, the frame assembly 22 that provides the structural foundation for the chassis 20 is formed preferably from a pair of closed rectangular frame rails 46 held in generally spaced parallel relationship by a plurality of cross members 48. In the configuration shown in the embodiment of FIGS. 1-7, there are four cross members 48 spaced, preferably spaced equidistantly, along the length of the frame rails 46. Front and rear bulkhead plates 58, 60 span the distance between the frame rails 46 and close off the respective front and rear ends of the frame rails 46. Each frame rail 46 has a closed construction consisting of an exterior sidewall 50, interior sidewall 52, and top and bottom walls 54, 56 all integrally formed to create the closed construction. While an open construction can be used, such as the interior sidewall being removed, the closed configuration is preferred for its strength as well as its durability, resistance to corrosion, and cleanliness because it avoids the accumulation of dirt and debris that is found in open rails. The manner of constructing each frame rail 46 is not described herein because it is done in a conventional manner, and one of ordinary skill would employ known techniques for fashioning the frame rails 46.

Each frame rail 46 has a substantially rectangular cross-sectional configuration with the exterior and interior sidewalls having the same length as the top and bottom walls, but the exterior and interior sidewalls 50, 52 having a greater height dimension than the width dimension of the top and bottom walls 54, 56. In a representative embodiment, the height of the exterior and interior sidewalls 50, 52 is approximately eight inches.

The cross members 48 are formed of round, cylindrical tubes, preferably hollow, and made of high strength steel that extend completely through each frame rail 46 so that the ends 62 project approximately one-half inch beyond the exterior sidewalls 50 of each frame rail 46. The cross members 48 are then welded to the frame rails 46 both on the interior and exterior sidewalls 50, 52.

A unique welding pattern is used to prevent failure of the welds due to the structural loads placed on the frame assembly 22. More particularly, the weld bead begins at a horizontal location and proceeds around the cross member and thence back to the beginning at the horizontal position. For example, when viewed on end, the bead begins at the 9 o'clock position and continues around clockwise back to the 9 o'clock position to form one continuous weld or weld bead. It could also start and stop at the 3 o'clock position. This construction substantially reduces joint failure when subjected to the particular stress of this type of trailer.

Ideally the cross members 48 are of the same constant diameter and the same length. For example, the cross members have approximately a six-inch outside diameter with a one-quarter inch thick wall that is formed using a drawn-over-mandrel technique, and each cross member has an eighty-thousand pound tensile strength.

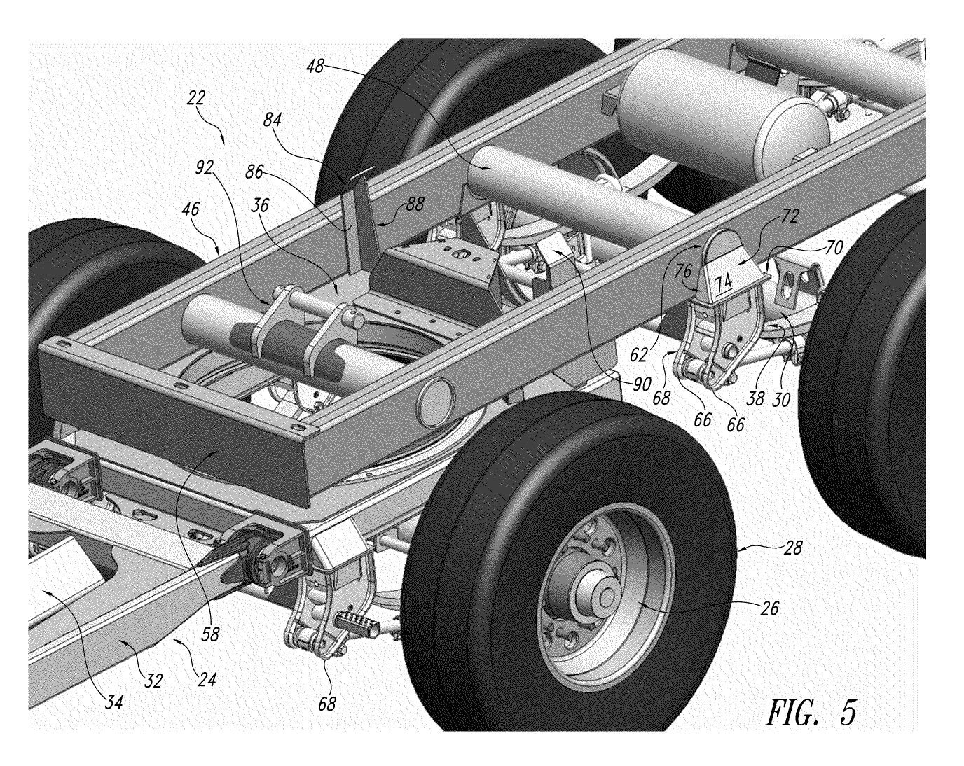

Suspension hangers 64 are positioned along the frame rails 46 at each location where the cross members 48 intersect the frame rails 46. These suspension hangers 64 are of a conventional construction and will not be described in detail herein. Briefly, they are used to attach the leaf springs 38 to the frame rails 46, and they include a yolk formed of two legs 66 that are suspended downward from the frame rail 46 in a straight configuration as shown on the two rear suspension hangers 64. A leading suspension hanger 68 with angled legs 66 that project forward is shown on the second cross member 48 from the front of the trailer. Another leading suspension hanger 68 is attached to the ring plate 36 as shown more clearly in FIG. 5 and its angled legs 66 also point in a forward direction.

Because the suspension hangers 64, 68 are readily commercially available, they will not be described in more detail herein. They are welded to the frame rails 46 with a bracket 70 that extends across the bottom wall 56 and up the interior wall 52 and around the bottom portion of the cross member 48. A suspension gusset 72 is welded to the top of the bracket 70 and on the exterior sidewall 50 of the frame rail 46 to partially cover the cross member end 62 that extends beyond the exterior sidewall 50. Ideally, the gusset has a slanted sidewall 74 and two end walls that cover almost the entirety of the exposed bracket 70. This provides strength to the suspension hanger 64 and facilitates in keeping debris off the suspension hangers 64, 68, and the associated bracket 70. The leading suspension hanger 68 on the dolly 94 has a similar bracket 70 and suspension gusset 72 that is attached to the dolly 94, which is described in more detail hereinbelow.

Rear suspension hangers 78 are attached to the rear bulkhead plate 60. These hangers 78 have a slightly different configuration than the leading suspension hanger 68 and midframe suspension hangers 64 in that they do not support or utilize a lateral suspension rod 80 that extends through both legs 66 of each of the midframe suspension hangers 64 and the first of the two leading suspension hangers 68.

The ring plate 36 is mounted adjacent the front bulkhead plate 58 and attached, preferably by welding, to the bottom wall 56 of both frame rails 46. The ring plate 36 extends rearward to approximately halfway between the first and second cross members 48. On the top surface of the ring plate 36 is mounted a bracket 82 for attachment of components unrelated to the present disclosure. Also mounted on the ring plate 36 are a pair of bed guides 84 having an upright wall 86 that is attached to the interior sidewall 52 of each frame rail 46 and a brace 88 extending outward from the upright wall 86 and attached to the ring plate 36. An angled guide plate 90 extends upward and inward from the upright wall 86 to act as a guide for a bed (not shown) that is hingedly attached to the frame assembly 22. A yoke assembly 92 is attached to the leading cross member 48 for use with hydraulics to raise and lower the bed, which are not shown or described herein inasmuch as they are readily commercially available and known to those skilled in the art.

Referring next to FIGS. 8 and 9, shown therein is a dolly 94 that attaches to the ring plate 36 as part of the chassis 20. The dolly has a substantially rectangular frame 96 from which depends the leading suspension hanger 68 at a forward end and a pair of brackets 98 at the rearward end. A pair of yokes 100 are mounted on a forward face of the frame 96 and project forward to receive the draw bar assembly 24 when attached to the frame assembly 22 in a conventional manner. The ring plate 36 attaches to the dolly frame 96 and includes a pair of spacers 104 on the top surface thereof. A generally circular opening 106 is formed in the ring plate 36.

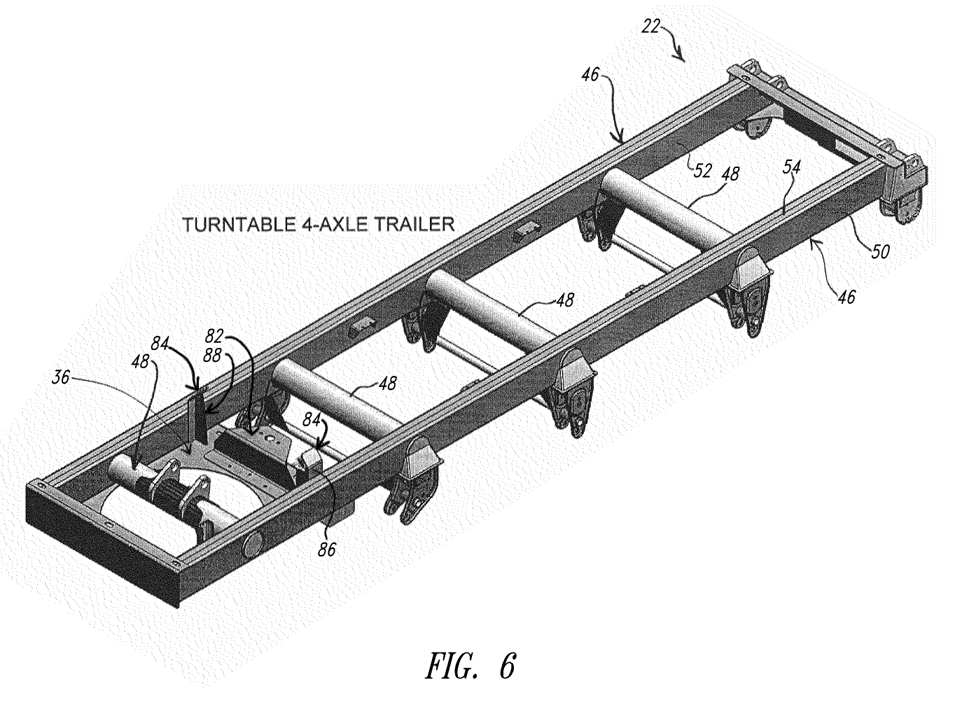

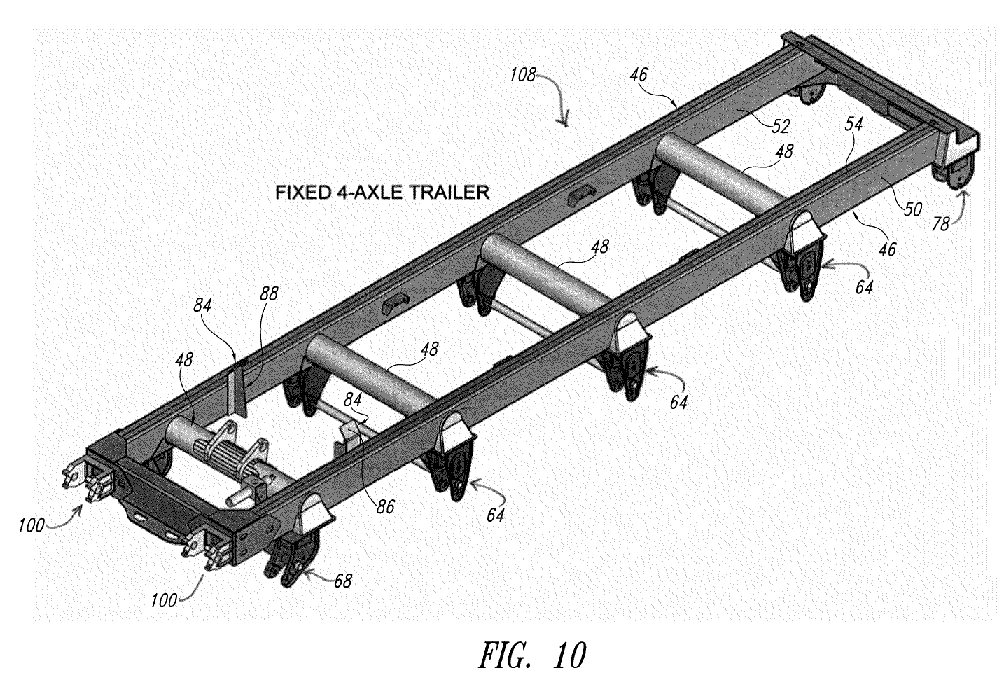

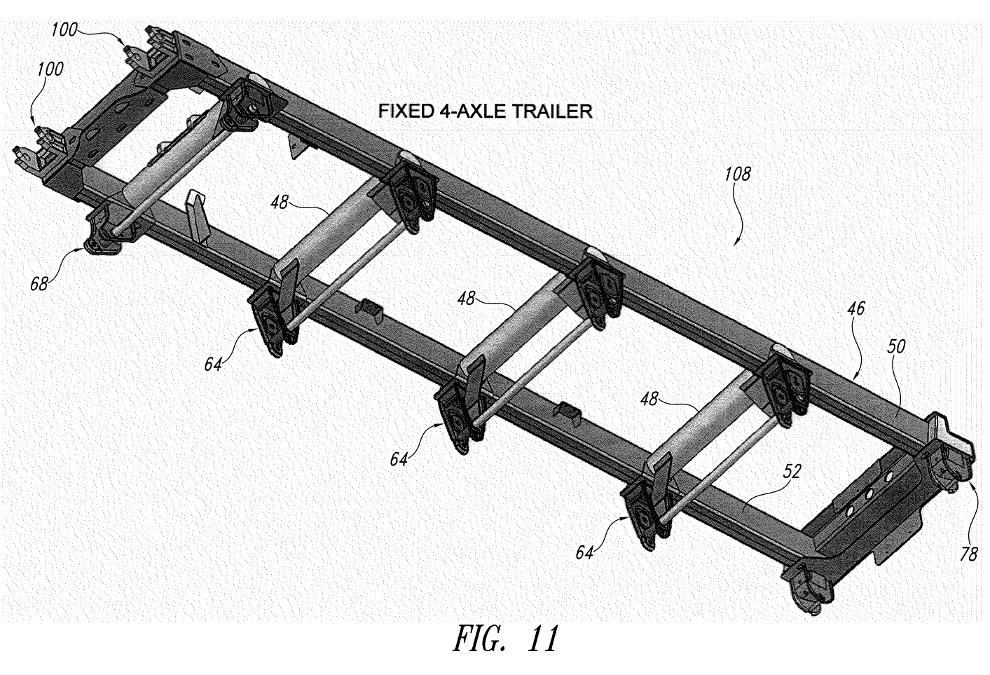

Referring next to FIGS. 10 and 11, shown therein is a fixed trailer frame assembly 108 that is nearly identical to the trailer frame assembly illustrated in FIG. 6. In this embodiment, the ring plate 36 and dolly 94 are not used inasmuch as the trailer does not have a turntable associated with the draw bar. As a result, there is no dolly as in the prior embodiment. The leading suspension hanger 68 is hence attached to the forward cross member location 48 on the frame rails 46 as shown. The draw bar yokes 100 are attached to the front bulkhead plate 58 and frame rails 46 as shown.

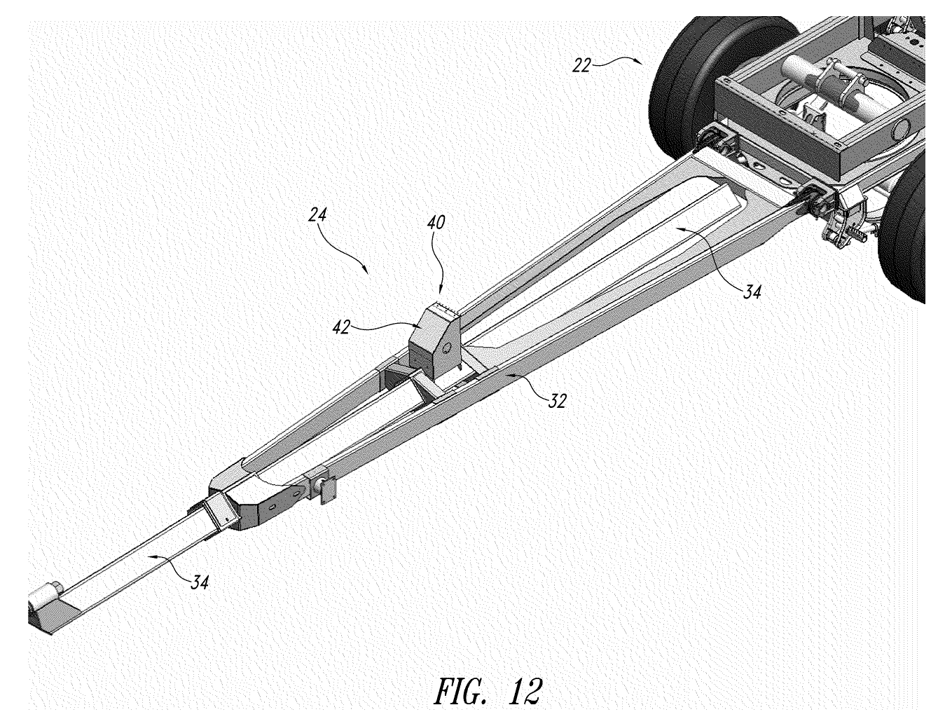

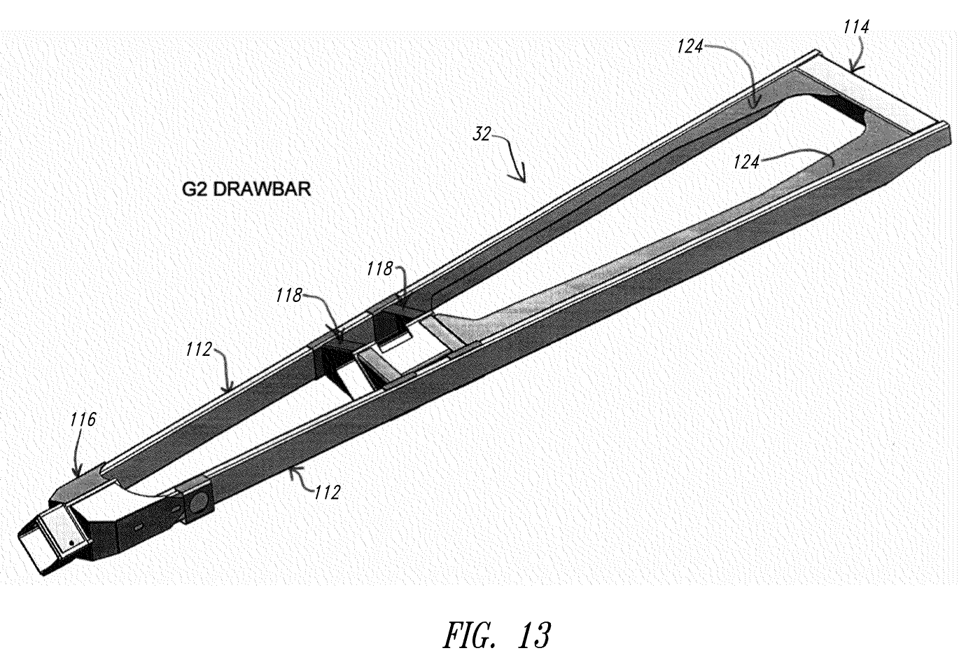

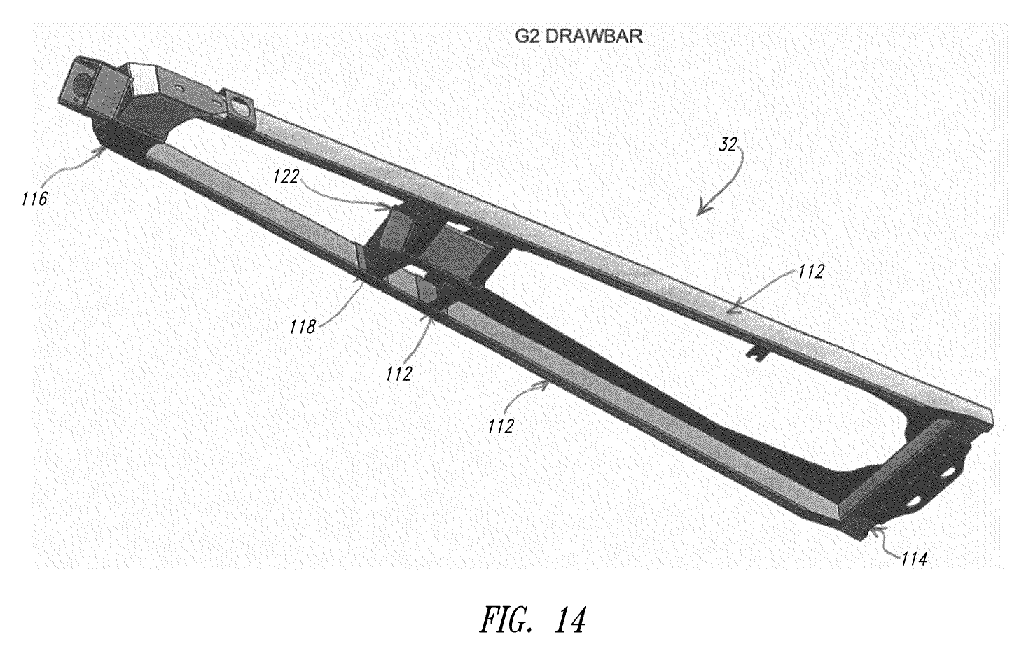

Turning next to FIGS. 12-14, shown therein is the drawbar assembly 24 (FIG. 12) with more detail of the outer reach 32 in FIGS. 13 and 14. More particularly, the outer reach 32 has a pair of longitudinal rails 112 connected together at one end by a cross beam 114 and converging together at the other end in a nose plate 116. A pair of mounting plates 118 for the reach lock 40 span the rails in spaced parallel relationship slightly forward of the midspan thereof. The inner reach 34 has a substantially square-shaped cross-sectional configuration and a length that is longer than the outer reach 32. The inner reach 34 is slidably received within a nose guide 120 in the nose plate 116, and then through a rear guide 122 mounted on the mounting plates 118. The nose guide 120 functions as a slide bearing as does the rear guide 122 for the inner reach 34. An opening in the top of the rear guide 122 provides access for a locking shoe (not shown) inside the reach lock housing 40. A top gusset 124 extends from the rear cross beam 114 to the first mounting plate 118 on each side of the outer reach 32 to provide strength and rigidity to the outer reach 32. The gussets 124 are shaped to have a reduced width about midway between the rearward mounting plate 118 and the rear cross beam 114, generally in the shape of a wide-angle V, and provide a large opening in the outer reach 32 for access to the inner reach 34 for inspection and positioning.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A trailer frame assembly, comprising:
a pair of closed, rectangular frame rails;
a plurality of round pipe cross members, each cross member extending completely through each rectangular frame rail; and
a plurality of axle suspension members mounted on each rectangular frame rail.

2. The assembly of claim 1 wherein each of the plurality of round pipe cross members is attached to the pair of rectangular frame rails wherein the frame rails are in spaced parallel relationship to one another and each cross member is attached at first and second ends to each respective frame rail, each cross member having the first and second ends extending through each rectangular frame rail to extend beyond an exterior sidewall of the respective frame rail.

3. The assembly of claim 2 wherein each cross member has the first and second ends welded to the respective frame rail, and wherein the weld bead completely encircles each round pipe cross member at the intersection of the first and second ends and respective frame rail interior and exterior walls, each weld beginning at a horizontal location on the cross member and proceeding around the cross member and back to the beginning of the weld at the horizontal position in a continuous weld bead.

4. The assembly of claim 3 wherein each of the first and second ends of each cross member project approximately one-half inch beyond the exterior sidewall of each frame rail.

5. The assembly of claim 4, comprising a suspension hanger attached to each of the first and second ends of each cross member and at the exterior sidewalls of each frame rail.

6. The assembly of claim 5 wherein each suspension hanger is attached to at least one axle suspension member.

7. The assembly of claim 4 wherein each frame rail has four suspension hangers attached thereto, with the forward three suspension hangers attached to respective cross members and a rearward most suspension hanger attached at a rearward end of the respective frame rail, and wherein the two middle suspension hangers comprise mid-frame suspension hangers that are configured to be attached to two leaf spring assemblies each and the forward most and rearward suspension hangers are configured to be attached to a single leaf spring assembly.

8. A trailer frame assembly, comprising:
a pair of closed, rectangular frame rails;
a plurality of round pipe cross members, each cross member extending completely through each rectangular frame rail; and
a draw bar assembly coupled to at least the rectangular frame rails, the draw bar assembly having an outer reach and an inner reach slidably mounted on the outer reach with a reach lock mounted on the outer reach and configured to lock the inner reach in selectable positions with respect to the outer reach, the reach lock having an access covering releasably secured thereto.

9. The assembly of claim 8 wherein each of the plurality of round pipe cross members is attached to the pair of rectangular frame rails wherein the frame rails are in spaced parallel relationship to one another and each cross member is attached at first and second ends to each respective frame rail, each cross member having the first and second ends extending through each rectangular frame rail to extend beyond an exterior sidewall of the frame rail.

10. The assembly of claim 9 wherein each cross member has the first and second ends welded to the respective frame rail, and wherein the weld bead completely encircles each round pipe cross member first and second end, each weld beginning at a horizontal location on the cross member and proceeding around the cross member and back to the beginning of the weld at the horizontal position.

11. The assembly of claim 10 wherein each of the first and second ends of each cross member project approximately one-half inch beyond the exterior sidewall of each frame rail.

12. The assembly of claim 11, comprising a suspension hanger attached to each of the first and second ends of each cross member and at the exterior sidewalls of each frame rail.

13. The assembly of claim 12 wherein each suspension hanger is attached to at least one axle suspension member.

14. The assembly of claim 11 wherein each frame rail has four suspension hangers attached thereto, with the forward three suspension hangers attached to respective cross members and a rearwardmost suspension hanger attached at a rearward end of the respective frame rail, and wherein the two middle suspension hangers comprise midframe suspension hangers that are configured to be attached to two leaf springs each and the forwardmost and rearward suspension hangers are configured to be attached to a single leaf spring.

15. The assembly of claim 9 wherein each suspension hanger is welded to the respective frame rail with a bracket that extends across a bottom wall of the frame rail and up an interior wall of the frame rail and further extending around a bottom portion of a cross member, the assembly further comprising a suspension gusset welded to a top of the bracket and the exterior sidewall of the frame rail to partially cover the respective first or second end of the cross member that extends beyond the exterior sidewall of the frame rail.

16. The assembly of claim 15 wherein the gusset comprises a slanted sidewall and two end walls that are both slanted downward and outward from the frame rail to protect the suspension hangers from debris.

17. The assembly of claim 8 wherein the inner reach is slidably received within a nose guide formed in a nose plate on the outer reach and through a rear guide mounted on mounting plates formed on the outer reach.

18. The assembly of claim 17, further comprising a top gusset extending from a rear cross beam on the frame rails to the mounting plates that support the rear guide on each side of the outer reach to provide strength and rigidity to the outer reach, the gussets shaped to have a reduced width midway between the rear cross beam and the first mounting plate, and having generally a plan form shape of a wide-angle V to form a large central opening in the outer reach.

19. The assembly of claim 18, further comprising a dolly coupled to a ring plate that is attached to the frame rails, the dolly comprising a pair of leading suspension hangers at a forward end and a pair of suspension brackets at a rearward end, and a pair of yokes mounted on a forward face of the dolly that project forward to receive the draw bar assembly, the dolly adapted to pivot about a vertical axis with respect to the ring plate.

20. The assembly of claim 17, further comprising a top gusset extending from the rear cross beam to the mounting plates that support the rear guide on each side of the outer reach, the gussets shaped to have a reduced width midway between the rear cross beam and the first mounting plate, and having generally a plan form shape of a wide-angle V to form a large central opening in the outer reach to provide access to the inner reach for inspection and positioning.
